(19) United States
(12) Patent Application Publication
(10) Pub. No.: US 2018/0109525 A1
(43) Pub. Date: Apr. 19, 2018

(54) ELECTRONIC COMPUTING DEVICE INCLUDING ONLINE CONNECTIVITY AND PERMANENTLY OFFLINE COMPUTING

(71) Applicant: KENNETH WRIGHT VANARSDEL, VANCOUVER, WA (US)

(72) Inventor: KENNETH WRIGHT VANARSDEL, VANCOUVER, WA (US)

(21) Appl. No.: 15/296,402

(22) Filed: Oct. 18, 2016

(51) Int. Cl. H04L 29/06

(52) U.S. Cl. CPC H04L 63/10

(57) ABSTRACT

A computing system includes two separate computer modules within the same computing housing. The computing system protects data from one computer from online threats by permanently keeping the computer offline and disconnected from networks or the Internet. Sensitive or important data may thus be worked on without fear of exposure to online threats that may sneak into the data storage using subterfuge or undetected entry. The user may switch to the other computer which has network connectivity to access network data or the Internet while the data in the offline computer is safely disconnected and protected from access by the other computer's connectivity.

### CROSS-REFERENCE TO RELATED APPLICATIONS

None.

### BACKGROUND

The embodiments herein relate generally to computing systems, and more particularly, to an electronic computing device that includes online connectivity and permanently offline computing.

Most of the current computing devices include connectivity to a telecommunications network (or short range connectivity for example, via Bluetooth® protocol) and are by default operating online. Thus, the data stored in computing devices are exposed to online threats and require various defenses to protect the content stored in memory. Billions of dollars are spent on firewalls, anti-virus, and other techniques that cannot guarantee that personal data won't be hacked or otherwise affected by those threats.

As can be seen, there is a need for a system that protects stored data in a computer while still providing online connectivity.

### SUMMARY

According to one embodiment of the present invention, a computing system for protecting sensitive data from online threats comprises a housing and a first computer housed by the housing. The first computer includes a first system memory, a first processing unit, a first data storage unit, and a network connection for access to a network or the Internet. The computing system also includes a second computer in the same housing as the first computer. The second computer includes a second system memory distinct from the first system memory, a second processing unit distinct from the first processing unit, and a second data storage unit distinct from the first data storage unit. The second computer does not have its own network connection and does not have connection to the network connection in the first computer which protects data stored in the second data storage unit from online threats.

### BRIEF DESCRIPTION OF THE FIGURES

The detailed description of some embodiments of the present invention is made below with reference to the accompanying figures, wherein like numerals represent corresponding parts of the figures.

FIG. 1 is a front perspective view of a mobile computing system with a dedicated display for an online connectable computing module and a second dedicated display for a permanently offline computing module in accordance with an exemplary embodiment of the subject technology;

FIG. 2 is an exploded view of a mobile computing system with a display in common with an online connectable module and a permanently offline computing module in accordance with another exemplary embodiment of the subject technology; and

FIG. 3 is a block diagram of a computing system incorporating online/offline connectivity in accordance with an exemplary embodiment of the subject technology.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

In general, the embodiments disclosed provide a computing system that includes one computing mode online and one computing mode permanently offline to protect data from online threats. In some embodiments, the computing modes may be two distinct computer systems packaged into a single device. The computer systems may share I/O interfaces but one computer system is never connectable to a network. The system may share some components, for example a processing unit, a display, and use of peripherals/external devices (e.g. mouse, keyboard, USB ports, etc.) or in some embodiments each computer system may have one or more of these components dedicated to respective systems so that there are two of each within the overall device. In an exemplary embodiment, the permanently offline computing mode has a data storage module that never has access to a network (and vice versa) and another data storage module that has access to a network. As will be appreciated, embodiments the system disclosed enables a user to enter data or store files onto a device that is never connected to the internet, and this ensures a high level of security for both privacy, and to enable that data to be trusted for scientific research. In the same device, a separate computer has full connectivity for the user's usual daily access to convenient wireless or wired online tasks.

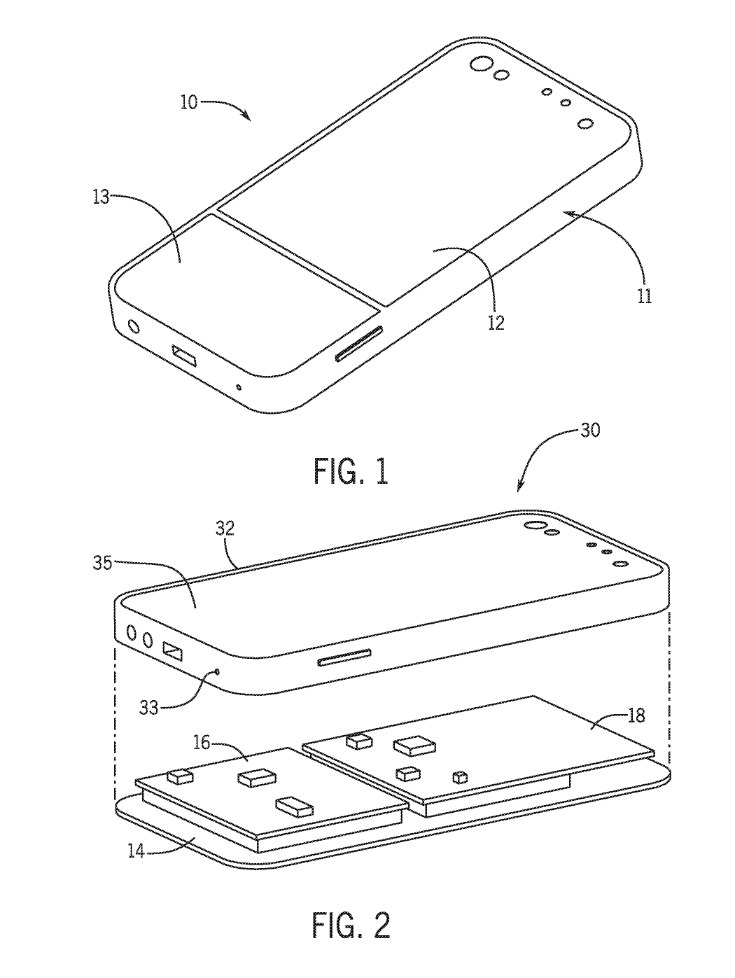

By way of example, and referring to FIGS. 1 and 2, a computing system 10 and computing system 30 are shown according to exemplary embodiments. The computing system 10 shows an embodiment that includes an offline (or permanently network disconnected) internal computing module and online (or network connectable) internal computing module which are hidden from view housed within a single housing 11 and using dedicated displays 12 and 13 for the online and offline systems respectively. As will be described with respect to FIG. 2 and more easily seen, the offline portion of the computing system 10 is never connected to nor has access to a wired or wireless connection. Thus the user may work with the offline computing module through the display 12 while working either separately or simultaneously with the online connectable portion through the display 13 without ever subjecting the data accessed through the display 12 (which is dedicated to the offline portion) to online risk.

The computing system 30 shows another embodiment using a shared display 35 and may be any computing device however the computing device 30 includes within a single housing 32, an offline (or permanently network disconnected) module 16 and an online (or network connectable) module 18. The modules 16 and 18 may be connected to a common substrate 14 for purposes of power supply and access to shared device features (for example, the commonly shared display 35, speakers 33, etc.). In some embodiments, the modules 16 and 18 may be on separate substrates 14 with distinct connections to shared features. However, the offline module 16 may never share a direct connection to the online module 18.

While the computing devices 10 and 30 are shown as a smart phone, it will be understood that other computing devices including for example, personal computer systems, tablet devices, mobile telephone devices, wearable computing devices (for example smart watches, smart glasses, computing headgear, and wrist-worn, pendant-worn, or clothing based computing gear), server computer systems, handheld or laptop devices, multiprocessor systems, microprocessor-based systems, set top boxes, programmable consumer electronics, network PCs, may be configured according to the description of the subject technology disclosed herein.

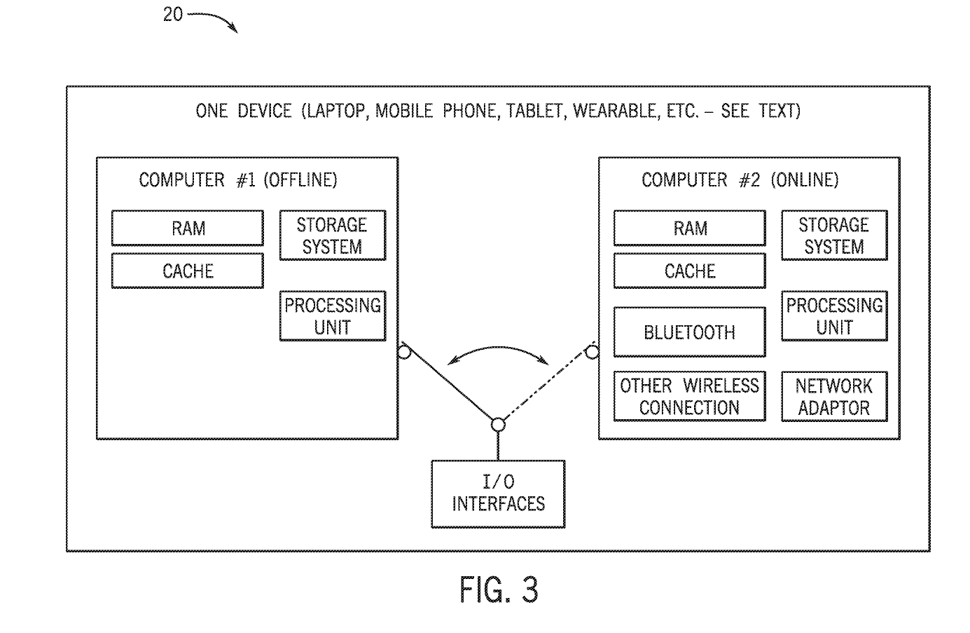

Referring now to FIG. 3, a block diagram of a computing system 20 is shown according to another exemplary embodiment. The computing system 20 includes an always offline computer (labeled “computer #1) and an online capable computer (labeled “computer #2). In some embodiments, the offline computer and online computer may share I/O interfaces so that for example, a single electronic display and keyboard is available to the user whether he or she is working with the offline computer or online computer. In some embodiments, the system 20 housing may include a switch toggling enablement of the I/O interfaces to either the offline computer or the online computer. In general, the I/O interfaces should not access the offline computer and the online computer simultaneously (for example, via switching windows in the display) to prevent access of the online computer's network connection interfaces to the offline computer data storage or memory.

The always offline computer may include system memory (RAM and cache), a processing unit, and a data storage system. The user may access the offline computer when working with data that the user wishes to protect from exposure to online threats. The offline computer may be operated as is known in the art through the use of peripheral devices and data is stored and accessed without access to a network or the Internet.

The online computer may include its own system memory (RAM and cache), processing unit, and data storage system that are distinct from the offline computer's system memory (RAM and cache), processing unit, and data storage system. In an exemplary embodiment, the online computer's system memory (RAM and cache), processing unit, and data storage system are physically disconnected from the offline computer's system memory (RAM and cache), processing unit, and data storage system, and preferable the system 20 does not include a trace or other connection between respective computer's memory, processing unit and data storage. In addition, the online computer may include network connection components including for example, a network adapter (for wired/Ethernet or wireless connectivity), a Bluetooth® module, or other wireless card. The online computer may be operated as is known in the art with the option to connect to a network or the Internet.

Data gathered from network connections is stored in the online computer without exposure or access to the offline computer. In the event the user wishes to transfer data from the online computer to the offline computer, the data must be saved to a physically separate file storage device (for example a flash drive, optical drive, etc.) from the online computer. The online computer is then toggled off and the offline computer is toggled on and data saved from the separate storage device is transferred to the offline data storage module. As may be appreciated, if the user wishes to pull data from a network connection for use in the offline computer, the data may be analyzed for risks (for example software viruses, malware, etc.) on the online computer side of the system 20 and once cleared for risks on the online side, may be transferred to a gateway risk analysis point in the offline side of the system 20 before being transferred safely to the offline side of the system 20.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A computing system for protecting sensitive data from online threats, comprising:
a housing;
a first computer housed by the housing, the first computer including a first system memory, a first processing unit, a first data storage unit, and a network connection for access to a network or the Internet; and
a second computer in the same housing as the first computer, the second computer including a second system memory distinct from the first system memory, a second processing unit distinct from the first processing unit, a second data storage unit distinct from the first data storage unit, wherein the second computer does not have its own network connection and does not have connection to the network connection in the first computer to protect data stored in the second data storage unit from online threats.

2. The computing system of claim 1, further comprising:
I/O interfaces coupled to the housing, the I/O interfaces; and
a switch selectively coupling to the first computer and the second computer to the I/O interfaces, wherein,
the switch being toggled to the first computer places the computing system in an online mode and
the switch being toggled to the second computer system places the computing system in an offline mode.

3. The computing system of claim 1, wherein the computing system is a smart phone, tablet device, laptop computer, or wearable device.
